(19) United States
(12) Patent Application Publication
(10) Pub. No.: US 2008/0034913 A1
(43) Pub. Date: Feb. 14, 2008

(54) Shift lever apparatus of automatic transmission and method of assembling the same

(75) Inventor: Yoshihiro Takikawa, Toyokawa-shi (JP)

Correspondence Address: THE NATH LAW GROUP, 112 South West Street, Alexandria, VA, 22314, US

(73) Assignee: FUJI KIKO Co. Ltd., Kosai-shi (JP)

(21) Appl. No.: 11/785,642

(22) Filed: Apr. 19, 2007

(30) Foreign Application Priority Data
Apr. 27, 2006 (JP) P2006-123565

(51) Int. Cl. G05G 7/08

(52) U.S. Cl. 74/473.33

(57) ABSTRACT

An upper rod having a guide groove at its lower end portion and a lower rod having a guide groove at its upper end portion are provided, a protrusion and a slit are provided on the lower rod and a lever main unit, respectively, and a lower rod position regulator which regulates a rotational position of the lower rod and a position thereof along a direction of a central axis to a position that matches a position pin insertion hole is provided. The upper rod, the lower rod, and a spring are inserted into a rod insertion hole of the lever main unit, a position pin attached to an insertion jig is inserted from the position pin insertion hole of the lever main unit, and the insertion jig inserted is entered in both guide grooves of the upper rod and the lower rod to push and separate the upper rod and the lower rod from each other, so that the position pin is interposed into a position between the upper rod and the lower rod.

### BACKGROUND OF THE INVENTION

1. Field of the Invention

The present invention relates to a shift lever apparatus of an automatic transmission mounted on an automobile or the like, and a method of assembling the same.

2. Description of the Related Art

Japanese Patent Application Laid-open No. H10-35309 discloses a shift lever apparatus of an automatic transmission, which is similar to the apparatus of the present invention. A shift lever apparatus 100 of an automatic transmission has a lever main unit 102 swingably provided to a support shaft 101 of a shifter main unit, as shown in FIG. 1. The lever main unit 102 includes a rod insertion hole 102a extending along an axial direction thereof and a position pin insertion hole 102b extending through the rod insertion hole 102a in a direction perpendicular to the axial direction. A rod 103 and a spring 104 are disposed in the rod insertion hole 102a. A position pin 105 positioned through the position pin insertion hole 102b is interposed between the rod 103 and the spring 104. The position pin 105 has an engagement protrusion 105a inserted into the rod 103, where it is prevented from dropping out of the lever main unit 102 by the engagement protrusion 105a. A portion of the position pin 105 extending beyond the lever main unit 102 is engaged with a lever position regulator (not shown). When the position pin 105 is moved downwardly, the portion is disengaged from the lever position regulator (not shown), so that swinging of the lever main body 102 is made possible.

A pusher member 106 is fixed on an upper end of the rod 103. When a knob button (not shown) provided on an upper end of the lever main unit 102 is pressed, the pusher member 106 is pressed downwardly.

With the configuration, when the knob button (not shown) provided on the upper end of the lever main unit 102 is pressed, the rod 103 is moved downwardly via the pusher member 106 according to the pressing operation. Thereby, the position pin 105 is moved downwardly along the position pin insertion hole 102b against a spring force of the spring 104. The lever main unit 102 is put in a swingable state according to downward movement of the position pin 105.

A work for assembling the rod 103, the position pin 105, and the spring 104 to the lever main unit 102 in the shift lever apparatus 100 is explained below. The lever main unit 102 is first attached to the support shaft 101. Next, the spring 104 is inserted into the rod insertion hole 102a of the lever main body 102 from the above. The position pin 105 is then disposed through the lever main unit 102 by putting the spring 104 in its compressed state and inserting the position pin 105 (an imaginary line position in FIG. 1) from the position insertion hole 102b. Next, the rod 103 is inserted into the rod insertion hole 102a of the lever main unit 102 from the above and the engagement protrusion 105a of the position pin 105 is inserted into the rod 103. Thus, assembling of the rod 103, the position pin 105, and the spring 104 to the lever main unit 102 is completed.

However, in the conventional shift lever apparatus 100 of an automatic transmission, the position pin 105 must be inserted into the position pin insertion hole 102b during assembling of the position pin 105 while the spring 104 in the lever main unit 102 is being compressed and deformed, which results in a trouble of assembling work.

Since the position pin 105 assembled to the lever main unit 102 must be protruded beyond the shifter main unit, it is convenient to perform an insertion work of the position pin 105 after the lever main unit 102 is assembled to the shifter main unit in view of a whole assembling easiness. However, since it is necessary to perform the insertion work of the position pin 105 while the spring 104 is being compressed and deformed, it is much difficult to assemble the position pin 105 after the lever main unit 102 is assembled to the shifter main unit.

### SUMMARY OF THE INVENTION

The present invention has been achieved in view of these circumstances, and an object of the invention is to provide a shift lever apparatus of an automatic transmission where assembling of a position pin can be performed easily after a lever main unit is assembled to a shift main unit, and a method of assembling the same.

To achieve the object, a first aspect of the present invention provides a shift lever apparatus of an automatic transmission comprising: a lever main unit that has a rod insertion hole provided along a central axis thereof and a position pin insertion hole extending through the rod insertion hole along a direction perpendicular to the central axis, and that is swingably supported to a shifter main unit; an upper rod that is disposed at an upper end side within the rod insertion hole to be movable along a direction of the central axis; a lower rod that is disposed at a lower end side within the rod insertion hole to be movable along a direction of the central axis; a position pin that is disposed so as to be sandwiched between the upper rod and the lower rod in the rod insertion hole while extending through the position pin insertion hole; and a spring that is disposed below a lower end of the lower rod in the rod insertion hole to bias and hold the upper rod, the position pin, and the lower rod on an upper side of the lever main unit, wherein the position pin insertion hole is set to be larger than a size of the position pin in the direction of the central axis, at least one of the a lower end portion of the upper rod and an upper end portion of the lower rod has a guide portion, and the lower rod includes a lower rod position regulator that performs regulating such that a rotational position of the upper end portion of the lower rod and a position thereof along the direction of the central axis match the position insertion hole.

A second aspect of the present invention provides the shift lever apparatus of an automatic transmission according to the first aspect, wherein the guide portion is a guide groove formed such that the position pin can be slid along the position pin insertion hole.

A third aspect of the present invention provides the shift lever apparatus of an automatic transmission according to the first or second aspect, wherein the lower rod position regulator comprises a protrusion provided on one of the lower rod and the lever main unit and a slit provided on the other so as to extend along the direction of the central axis and the protrusion is inserted therein.

A fourth aspect of the present invention provides the shift lever apparatus of an automatic transmission according to one aspect among the first aspect to the third aspect, wherein an upper side fitting structure is provided between the lower end portion of the upper rod and an upper end portion of the position pin and a lower side fitting structure is provided between a lower end portion of the position pin and the upper end portion of the lower rod.

A fifth aspect of the present invention provides the shift lever apparatus of an automatic transmission according to the fourth aspect, wherein the upper side fitting structure comprises an upper engagement hole formed at the lower end portion of the upper rod, and an upper engagement protrusion formed on the upper end portion of the position pin to be engageable with the upper engagement hole, and the lower side fitting structure comprises a lower engagement protrusion formed on the lower end portion of the position pin, and a lower engagement hole formed on the upper end portion of the lower rod so as to be engageable with the lower engagement protrusion.

A sixth aspect of the present invention provides a method of assembling a shift lever apparatus of an automatic transmission, wherein the shift lever apparatus comprising a lever main unit that has a rod insertion hole provided along a central axis thereof and a position pin insertion hole extending through the rod insertion hole along a direction perpendicular to the central axis, and that is swingably supported to a shifter main unit; an upper rod that is disposed at an upper end side within the rod insertion hole to be movable along a direction of the central axis; a lower rod that is disposed at a lower end side within the rod insertion hole to be movable along a direction of the central axis; a position pin that is disposed so as to be sandwiched between the upper rod and the lower rod in the rod insertion hole while extending through the position pin insertion hole; and a spring that is disposed below a lower end of the lower rod in the rod insertion hole to bias and hold the upper rod, the position pin, and the lower rod on an upper side of the lever main unit, and the method comprising: a step of inserting the upper rod, the lower rod, and the spring into the rod insertion hole from a lower end of the lever main unit in this order and disposing the lever main unit in the shifter main unit; a step of assembling an insertion jig that is attachable and detachable to the position pin and that is set such that a distal end portion thereof in an insertion direction is tapered, and a rear end portion thereof in the insertion direction is set to be larger than a size of the position pin in the direction of the central axis; a step of inserting the insertion jig attached to the position pin into the position pin insertion hole and pushing the insertion jig into a guide portion formed on at least one of a lower end portion of the upper rod and an upper end portion of the lower rod to dispose the position pin between the upper rod and the lower rod while sliding the upper rod and the lower rod; and a step of detaching the insertion jig from the position pin disposed between the upper rod and the lower rod.

As explained above, according to the first aspect, since an upper end of the lower rod is positioned at the position pin insertion hole by the upper rod position regulator and the guide portion is positioned at a position that matches the position pin insertion hole by regulation of a position of the lower rod in the central axial direction according to insertion of the upper rod, the lower rod, and the spring into the rod insertion hole of the lever main unit, the position pin can be disposed to extend between the upper rod and the lower rod by inserting the position pin while separating the upper rod and the lower rod from each other via the position pin insertion hole of the lever main unit. Accordingly, assembling of the position pin can be easily performed after the lever main unit is assembled to the shifter main unit.

According to the second aspect, in addition to the effect of the first aspect, the position pin can be assembled while it is being slid in the guide groove, which can result in improvement of assembling workability.

According to the third aspect, in addition to the effects of the first and second aspects, the lower rod regulator can be disposed without complicating a configuration of the shift lever apparatus.

According to the fourth aspect, in addition to the effects of the second and third aspects, since the lower end portion of the upper rod and the upper end portion of the lower rod are fitted to each other through the upper side fitting structure, and the lower end portion of the position pin and the upper end portion of the lower rod are fitted to each other through the lower side fitting structure, motion transmission from the upper rod to the position pin can be performed reliably.

The fifth aspect can achieve the same effect as that of the fourth aspect.

According to the sixth aspect, assembling can be achieved by simply inserting the position pin attached to the insertion jig into the guide portion. Thereby, assembling of the position pin can be simply performed after the lever main unit is assembled to the shifter main unit.

### BRIEF DESCRIPTION OF THE DRAWINGS

The above and further objects and novel features of the present invention will more fully appear from the following detailed description when the same is read in conjunction with the accompanying drawings, in which:

FIG. 1 is a sectional view of relevant parts of a conventional shift lever apparatus;

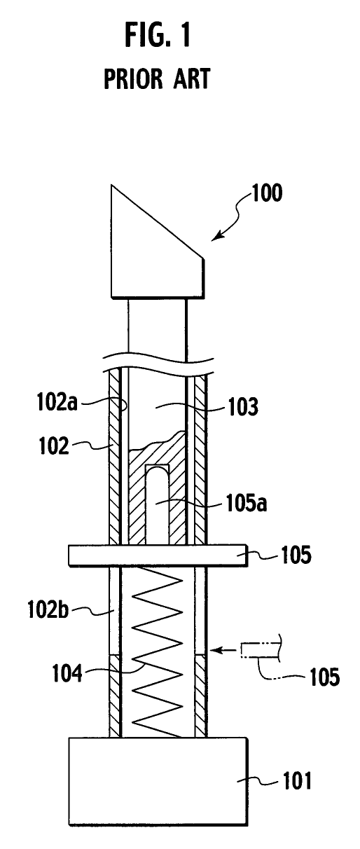

FIG. 2 is a perspective view of a shift lever apparatus of an automatic transmission according to an embodiment of the present invention;

FIG. 3 is a perspective view of a lever main unit according to the embodiment assembled with inner parts;

FIG. 4 is an exploded perspective view of the lever main unit according to the embodiment assembled with inner parts;

FIG. 5 is a sectional view of the lever main unit according to the embodiment assembled with inner parts;

FIG. 6 is a perspective view of relevant parts of an upper rod and a lower rod according to the embodiment;

FIG. 7 is a sectional view of the relevant parts of the upper rod and the lower rod according to the embodiment;

FIG. 8 is a perspective view of relevant parts of the lever main unit according to the embodiment, seen from a lower end thereof;

FIG. 9 is a perspective view of relevant parts showing assembling of a position pin according to the embodiment attached to an insertion jig;

FIG. 10 is a sectional view showing a halfway state of inserting the position pin according to the embodiment attached to the insertion jig into the lever main unit from the outside of a main unit bracket; and

FIG. 11 is a sectional view showing a halfway state of inserting the position pin according to the embodiment attached to the insertion jig further than a position shown in FIG. 10.

### DETAILED DESCRIPTION OF THE PREFERRED EMBODIMENTS

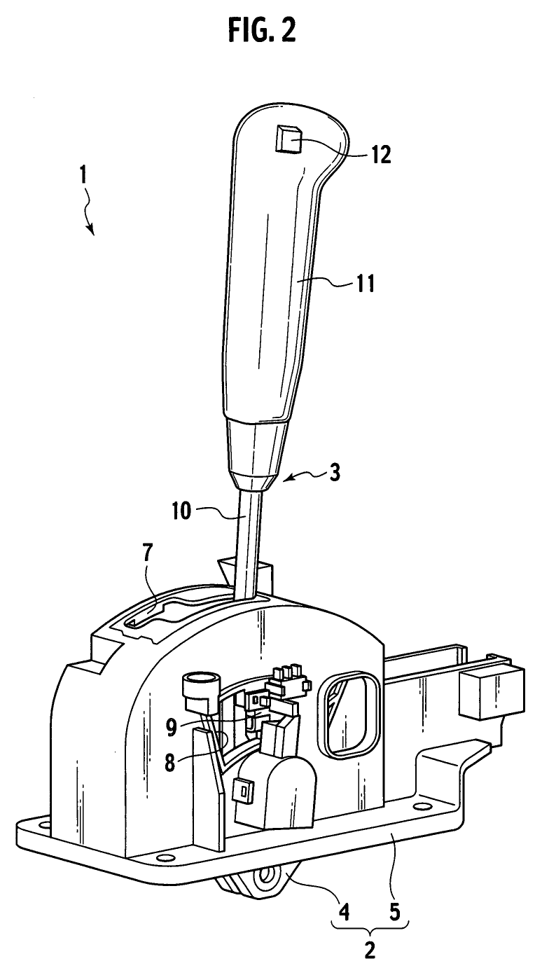

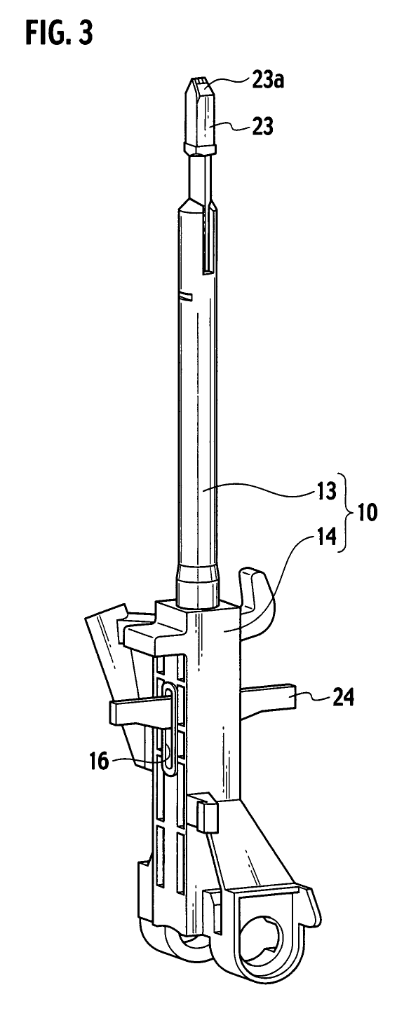

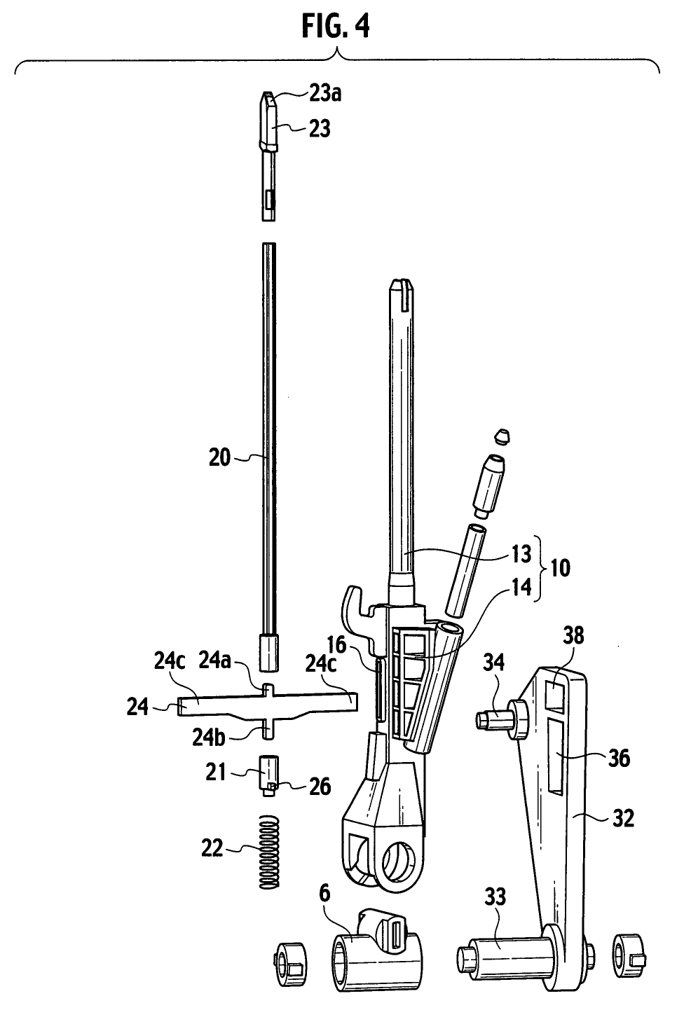

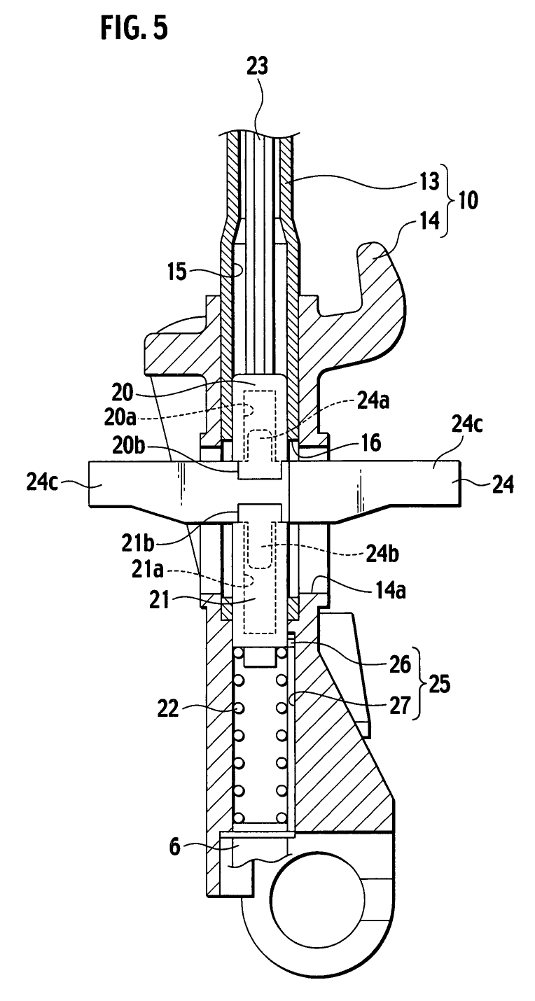

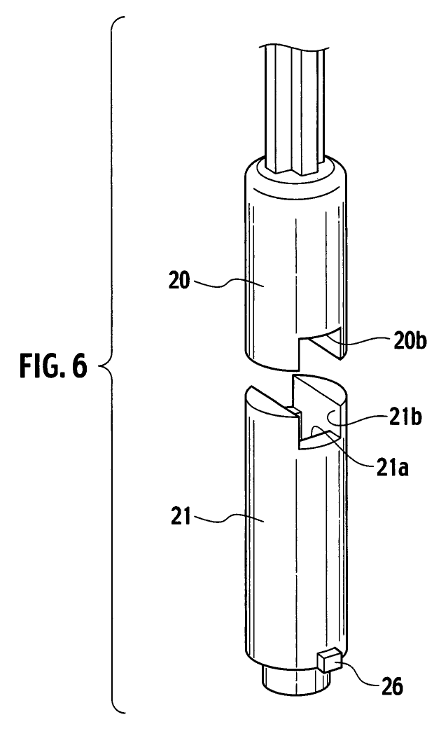

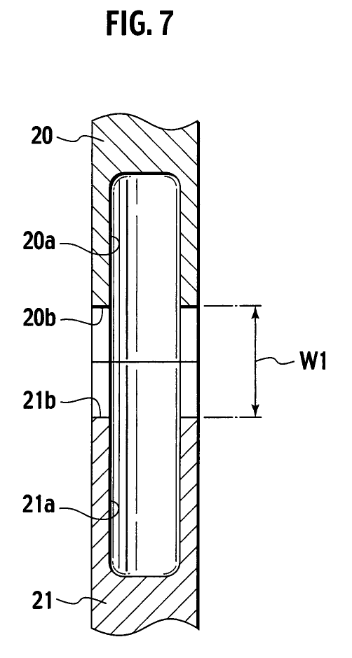

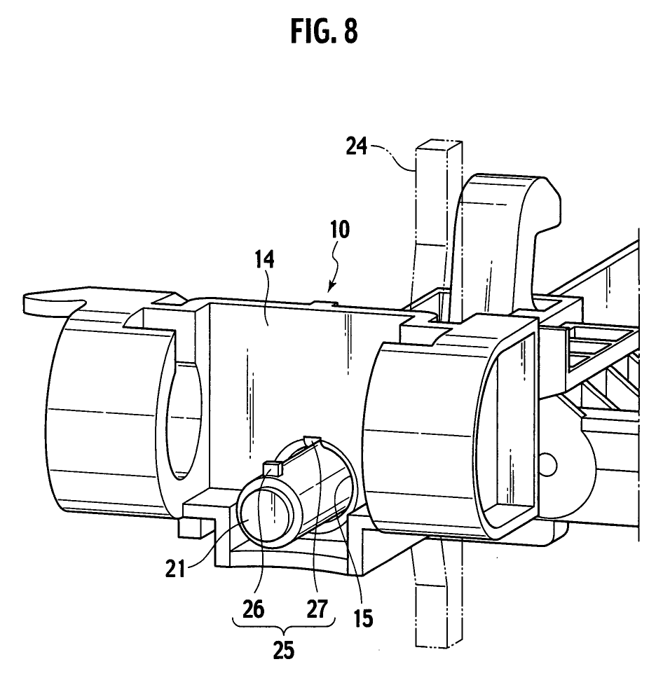

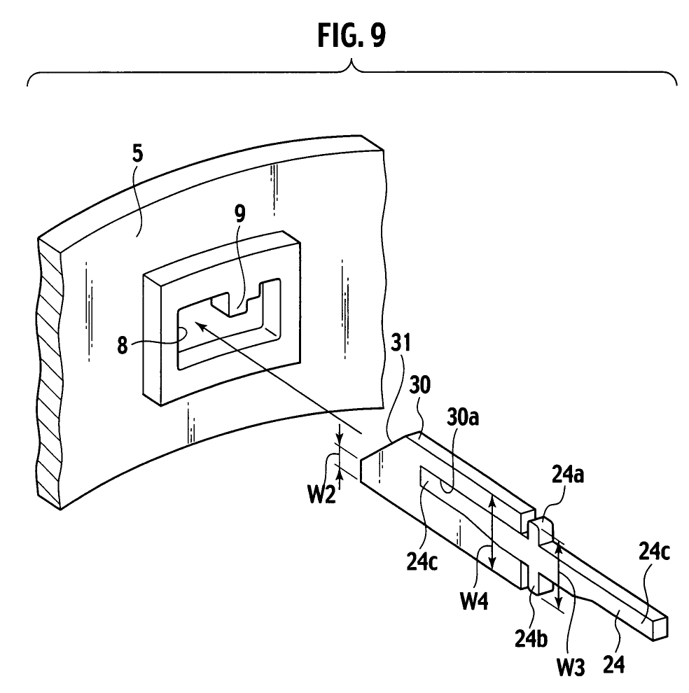

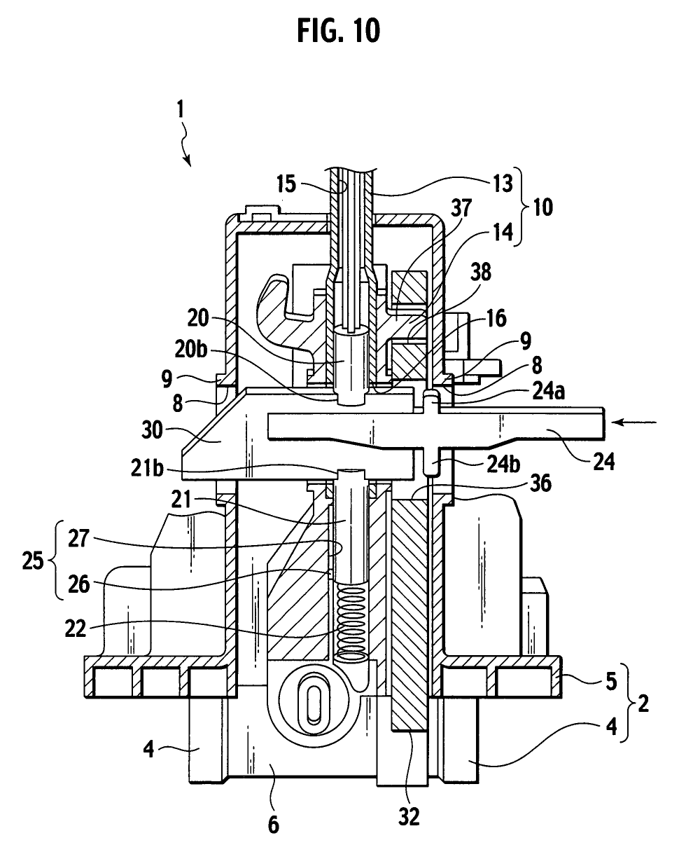

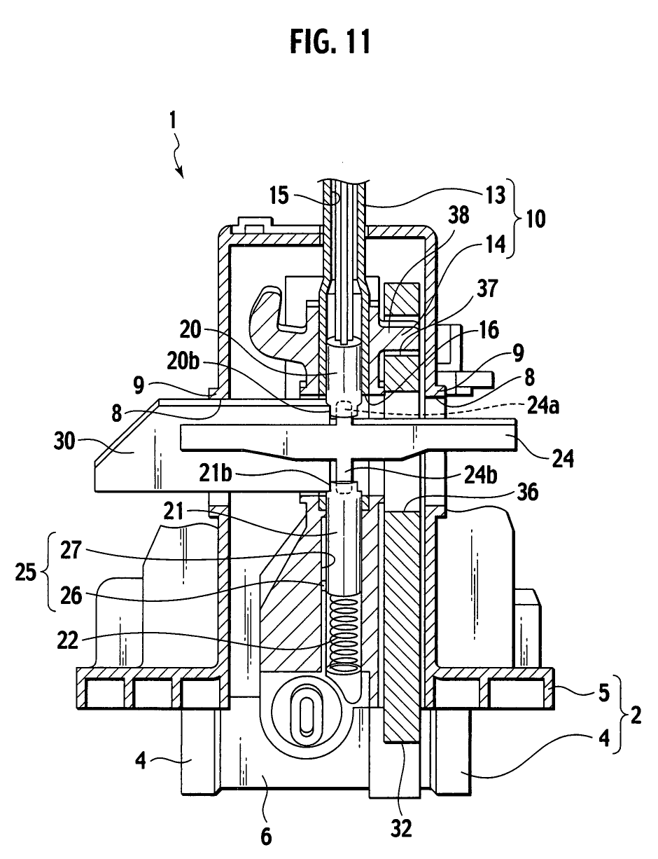

An embodiment of the present invention will be explained below in detail with reference to the accompanying drawings. FIG. 2 to FIG. 11 show the embodiment of the present invention, where FIG. 2 is a perspective view of a shift lever apparatus of an automatic transmission, FIG. 3 is a perspective view of a lever main unit assembled with inner parts, FIG. 4 is an exploded perspective view of the lever main unit assembled with the inner parts, FIG. 5 is a sectional view of the lever main unit assembled with the inner parts, FIG. 6 is a perspective view of relevant parts of an upper rod and a lower rod, FIG. 7 is a sectional view of the relevant parts of the upper rod and the lower rod, FIG. 8 is a perspective view of relevant parts the lever main unit, seen from a lower end thereof, FIG. 9 is a perspective view of relevant parts showing assembling of a position pin attached to an insertion jig, FIG. 10 is a sectional view showing a halfway state of inserting the position pin attached to the insertion jig into the lever main unit from the outside of a main unit bracket, and FIG. 11 is a sectional view showing a halfway state of inserting the position pin attached to the insertion jig further than a position shown in FIG. 10. In the embodiment explained below, a distal end side of the lever main unit is deemed as an upper side and a proximal end side thereof is deemed as a lower side.

As shown in FIG. 2, FIG. 10, and FIG. 11, a shift lever apparatus 1 of an automatic transmission includes a shifter main unit 2 fixed to a vehicle body and an operation lever 3 protruded from the shifter main unit 2 upwardly.

The shifter main unit 2 includes a pivotally-supporting portion 4 and a main unit bracket 5 disposed so as to cover the same. A lever supporting base 6 is rotatably supported by the pivotally-supporting portion 4. An operation lever insertion hole 7 is formed on an upper face portion of the main unit bracket 5, and position holes 8 (the details are shown in FIG. 9) having lever regulators 9 (the details are shown in FIG. 9) are provided on left and right side faces thereof.

The operation lever 3 includes a lever main unit 10 and a knob portion 11 fixed to an upper end of the lever main unit 10. The knob portion 11 includes a knob button 12 for unlocking the operation lever 3.

As shown in FIG. 3 to FIG. 5 in detail, the lever main unit 10 includes a cylindrical portion 13 made of metal and a base 14 made of synthetic resin and integrally fixed with a lower end of the cylindrical portion 3. A rod insertion hole 15 whose diameter is gradually reduced upwardly is formed in the cylindrical portion 13 of the lever main unit 10 so as to extend along a direction of the central axis of the cylindrical portion 13. A position pin insertion hole 16 extending through the rod insertion hole 15 is formed in a direction perpendicular to the direction of the central axis of the cylindrical hole 13 of the lever main unit 10. A width of the position pin insertion hole 16 has a size slightly larger than a thickness width size of a position pin 24 described below, and a size of the position pin insertion hole 16 in its vertical direction is set to be larger than a size of the position pin 24 in its vertical direction. An insertion hole 14a having approximately the same shape as the position pin insertion hole 16 is provided in the base 14 made of synthetic resin.

An upper rod 20, the position pin 24, a lower rod 21, and a spring 22 are inserted in the rod insertion hole 15 of the lever main unit 10 in a descending order. A push rod 23 is disposed on the upper rod 20. A cam face 23a is formed on an upper end face of the push rod 23, where a pressing operation to the knob button 12 is converted to a downward movement of the push rod 23 by the cam face 23a.

The position pin 24 is caused to extend through in the position pin insertion hole 16 of the lever main unit 10. The position pin 24 is interposed between the upper rod 20 and the lower rod 21.

As shown in FIG. 6 and FIG. 7 in details, an upper and a lower engagement holes 20a and 21a are formed in a lower end portion of the upper rod 20 and an upper end potion of the lower rod 21, and guide grooves 20b and 21b serving as guide portions and extending through the engagement holes 20a and 21a are formed therein, respectively. The respective guide grooves 20b and 21b are formed in a square shape and their width sizes are set to be slightly larger than a width size of the position pin 24.

The position pin 24 is engaged with the respective guide grooves 20b and 21b of the upper rod 20 and the lower rod 21, respectively. An upper and a lower engagement protrusions 24a and 24b which respectively protrude upwardly and downwardly are provided on an upper end portion and a lower end portion of the position pin 24. The respective upper and lower engagement protrusions 24a and 24b are engaged with the respective engagement holes 20a and 21a of the upper rod 20 and the lower rod 21, respectively. The position pin 24 is prevented from dropping out from the lever main unit 10 through engagement of the upper and lower engagement protrusions 24a and 24b with the upper rod 20 and the lower rod 21. The position pin 24 includes an arm portion 24c engageable with the lever position regulator 9 of the position hole 8 in a state that the lever main body 10 has been assembled to the shifter main unit 2.

The upper engagement hole 20a formed at the lower end portion of the upper rod 20 and the upper engagement protrusion 24a constitute an upper side fitting structure which is located between the lower end portion of the upper rod 20 and an upper end portion of the position pin 24. On the other hand, the lower engagement hole 21a formed on the upper end portion of the lower rod 21 and the lower engagement protrusion 24b constitute a lower side fitting structure which is located between a lower end portion of the position pin 24 and the upper end portion of the lower rod 21.

As shown in FIG. 5 and FIG. 8, a lower rod position regulator unit 25 for regulating a rotational position of the lower rod 21 and a position thereof along the direction of the central axis, to a position that matches the position pin insertion hole 16 is provided on the lever main unit 10 and the lower rod 21. The lower rod position regulator unit 25 includes a protrusion portion 26 upright provided on an outer peripheral face of the lower rod 21 and a slit 27 provided on the lever main unit 10 along the rod insertion hole 15 thereof. The lower rod 21 can be inserted into the rod insertion hole 15 only at a rotational position where the protrusion portion 26 is inserted into the slit 27, and it is prevented from moving upwardly beyond a position where the protrusion portion 26 abuts on an upper end of the slit 27. Thereby, the lower rod 21 biased upwardly by a spring force of the spring 22 before it is inserted into the position pin insertion hole 16 is set such that its rotational position and height position match the position pin insertion hole 16.

An assembling procedure of the shift lever apparatus 1 is briefly explained next. Since an insertion jig 30 is used for the assembling, a configuration of the insertion jig 30 is explained here. As shown in FIG. 9 to FIG. 11, the insertion jig 30 has a fitting groove 30a, where the insertion jig 30 is attached to the position pin 24 by fitting the fitting groove 30a on the arm portion 24c of the position pin 24. The insertion jig 30 has a taper portion 31 that gradually expands from its distal end toward a rear end. A width W2 of the distal end portion of the insertion jig 30 is set to be smaller than a total vertical size W1 (see FIG. 7) of vertical widths of the guide grooves 20b and 21b of both the upper rod 20 and the lower rod 21, and a maximum width W4 is set to be larger than a vertical size W3 between tops of the upper and lower engagement protrusions 24a and 24b of the position pin 24. A size of the insertion jig 30 is set to be formed to have a gap between the insertion jig 30 and each of the engagement protrusions 24a and 24b.

An outline of assembling of the shift lever apparatus 1 is explained below. The upper rod 20, the lower rod 21, and the spring 22 are inserted into the rod insertion hole 15 of the lever main unit 10 from the below in this order, and a lower end portion of the lever main unit 10 is attached to the lever supporting base 6 of the pivotally-supporting portion 4 serving as a plug such that the rods and spring do not drop off from the rod insertion hole 15, thereby swingably supporting the lever main unit 10. The guide groove 21b of the lower rod 21 is positioned at a position that matches the position pin insertion hole 16 by the lower rod regulator 25, and at least a height position of the guide groove 20b of the upper rod 20 is positioned at a position that matches the position pin insertion hole 16 according to regulation of the position of the lower rod 21 along the direction of the central axis.

Next, the main body bracket 5 is disposed such that the lever main unit 10 projects from the operation lever insertion hole 7 of the main unit bracket 5 and the lever main unit 10 is rotatably attached to the pivotally-supporting portion 4 via a shaft supporting portion 33 of a cable lever 32. The cable lever 32 is provided on a shift lever apparatus with a manual mode, and it includes an engagement unit 34 that engages a cable (not shown) which controls the transmission. The cable lever 32 includes an insertion hole 36 inserted with the position pin 24 and an engagement hole 38 engaged with an engagement portion 37 formed on the base 14 such that the cable lever 32 and the lever main unit 10 are integrally rotated in an ordinary operation. The lever main unit 10 is disengaged from the cable lever 32 during a manual mode operation so that it can be rotated alone. Since the lever main unit 10 is not assembled with the position pin 24, the main unit bracket 5 can be easily attached to the pivotally-supporting portion 4.

Next, when the position of the guide groove 20b of the upper rod 20 does not match the position of the position pin insertion hole 16, positioning is performed. The positioning can be performed during the next insertion work of the position pin 24.

Next, as shown in FIG. 9, the position pin 24 attached to the insertion jig 30 is inserted from one position hole 8 of the main unit bracket 5. Thereby, the distal end portion of the insertion jig 30 inserted from the one position hole 8 passes through the insertion hole 36 of the cable lever 32 to be inserted into the insertion hole 14a of the base 14 of the lever main unit 10 and the position pin insertion hole 16 and enters in both the guide grooves 20b and 21b of the upper rod 20 and the lower rod 21. When the position pin 24 is further inserted from this state, the insertion jig 30 presses the upper rod 20 and the lower rod 21 upwardly and downwardly via both the guide grooves 20b and 21b. Thereby, the upper rod 20 is moved upwardly against its own weight, while the lower rod 21 is moved downwardly against a spring force of the spring 22, so that the insertion jig 30 is gradually inserted in the guide grooves 20b and 21b. As shown in FIG. 9, a space larger than the vertical size W3 between the tops of the upper and lower engagement protrusions 24a and 24b of the position pin 24 is formed between the upper rod 20 and the lower rod 21 according to advance of the insertion jig 30. As shown in FIG. 11, after the insertion jig 30 passes through between the upper rod 20 and the lower rod 21, the upper and lower engagement protrusions 24a and 24b of the position pin 24 is positioned between the upper rod 20 and the lower rod 21. Since a gap is formed between the insertion jig 30 and each of the engagement protrusions 24a and 24b, the upper and lower engagement protrusions 24a and 24b of the position pin 24 are inserted into the engagement hole 20a of the upper rod 20 dropping due to its own weight and the engagement hole 21a of the lower rod 21 raised by the spring force of the spring 22, respectively.

Finally, the insertion jig 30 projecting from the other position hole 8 of the main unit bracket 5 is detached from the position pin 24. Thus, assembling of the upper rod 20, the lower rod 21, the spring 22, and the position pin 24 to the lever main unit 10 is completed.

Thereafter, assembling of the operation lever 3 is completed by inserting the push rod 23 into the rod insertion hole 15 of the lever main unit 10 from the above and assembling the knob portion 11 to an upper portion of the lever main unit 10.

As explained regarding the assembling work, when the upper rod 20, the lower rod 21, and the spring 22 are inserted into the rod insertion hole 15 of the lever main unit 10, the guide groove 21b of the lower rod 21 is positioned so as to match the position pin insertion hole 16 by the lower rod position regulator 25 and at least the height position of the guide groove 20b of the upper rod 20 is positioned so as to match the position pin insertion hole 16 according to regulation of the position of the lower rod 21 along the direction of the central axis. Therefore, when the rotational position of the upper rod 30 does not match the position of the position pin insertion hole 16, they are aligned with each other by rotating the upper rod 30, so that assembling of the position pin 24 can be completed by simply inserting the position pin 24 attached to the insertion jig 30 into the position pin insertion hole 16 of the lever main unit 10. Thus, the assembling of the position pin 24 can be easily conducted after the lever main unit 10 is assembled to the shifter main unit 2.

In the present embodiment, since the lower rod position regulator 25 is composed of the protrusion portion 26 provided on the lower rod 21 and the slit 27 provided along the direction of the central axis of the lever main unit 10 and inserted with the protrusion portion 26, the lower rod position regulator 25 can be produced easily. Contrary to the present embodiment, the lower rod position regulator 25 can include the protrusion 26 provided on the lever main unit 10 and the slit 27 formed on the lower rod 21.

In the present embodiment, since the respective guide grooves 20b and 21b are set to a size that the position pin 24 is fitted therein, a relative rotation of the position pin 24, and the upper rod 20a and the lower rod 21 is prevented and coupling therebetween is made firm, so that motion transmission from the upper rod 20 to the position pin 24 can be performed reliably. In the present embodiment, since the guide grooves 20b and 21b, and the position pin 24 fitted therein are each formed in a square shape, so that they come in contact with each other via their flat faces, where chattering due to wear can be prevented as much as possible. Although the shift lever apparatus with the manual mode has been explained in the present embodiment, the present invention is not limited thereto, and the invention can be also applied to an ordinary shift lever apparatus that does not include the manual mode.

The entire contents of Japanese Patent Application No. 2006-123565 (filed on Apr. 27, 2006) are incorporated herein by reference.

Although the invention has been described above by reference to certain embodiments of the invention, the invention is not limited to the embodiments described above. Modifications and variations of the embodiments described above will occur to those skilled in the art, in light of the above teachings. The scope of the invention is defined with reference to the following claims.

What is claimed is:

1. A shift lever apparatus of an automatic transmission, comprising:
a lever main unit having a rod insertion hole formed along a central axis of the lever main unit and a position pin insertion hole extending through the rod insertion hole along a direction perpendicular to the central axis, the lever main unit swingably supported to a shifter main unit;
an upper rod disposed at an upper end side in the rod insertion hole so as to be movable along a direction of the central axis;
a lower rod disposed at a lower end side in the rod insertion hole so as to be movable along the direction of the central axis;
a position pin disposed so as to be sandwiched between the upper rod and the lower rod in the rod insertion hole while extending through the position pin insertion hole; and
a spring disposed below a lower end of the lower rod in the rod insertion hole so as to bias and hold the upper rod, the position pin, and the lower rod on an upper end side of the lever main unit, wherein
the position pin insertion hole is set to be larger than a size of the position pin in the direction of the central axis;
at least one of the a lower end portion of the upper rod and an upper end portion of the lower rod has a guide portion; and
the lower rod includes a lower rod position regulator regulating a rotational position and a position in the direction of the central axis of the upper end portion of the lower rod so as to match up to the position insertion hole.

2. The shift lever apparatus of an automatic transmission according to claim 1, wherein
the guide portion is a guide groove formed along the position pin insertion hole so that the position pin can be slid.

3. The shift lever apparatus of an automatic transmission according to claim 1, wherein the lower rod position regulator comprises:
a protrusion provided on one of the lower rod and the lever main unit; and
a slit provided on the other so as to extend along the direction of the central axis so that the protrusion is inserted into the slit.

4. The shift lever apparatus of an automatic transmission according to claim 1, wherein
an upper side fitting structure is provided between the lower end portion of the upper rod and an upper end portion of the position pin; and
a lower side fitting structure is provided between a lower end portion of the position pin and the upper end portion of the lower rod.

5. The shift lever apparatus of an automatic transmission according to claim 4,
wherein the upper side fitting structure comprises:
an upper engagement hole formed at the lower end portion of the upper rod; and
an upper engagement protrusion formed on the upper end portion of the position pin so as to be engageable with the upper engagement hole; and
wherein the lower side fitting structure comprises:
a lower engagement protrusion formed on the lower end portion of the position pin; and
a lower engagement hole formed on the upper end portion of the lower rod so as to be engageable with the lower engagement protrusion.

6. A method of assembling a shift lever apparatus of an automatic transmission wherein the shift lever apparatus comprises:
a lever main unit having a rod insertion hole formed along a central axis of the lever main unit and a position pin insertion hole extending through the rod insertion hole along a direction perpendicular to the central axis, the lever main unit swingably supported to a shifter main unit;
an upper rod disposed at an upper end side in the rod insertion hole so as to be movable along a direction of the central axis;
a lower rod disposed at a lower end side in the rod insertion hole so as to be movable along the direction of the central axis;
a position pin disposed so as to be sandwiched between the upper rod and the lower rod in the rod insertion hole while extending through the position pin insertion hole; and
a spring disposed below a lower end of the lower rod in the rod insertion hole so as to bias and hold the upper rod, the position pin, and the lower rod on an upper end side of the lever main unit,
the method, comprising the steps of:
inserting the upper rod, the lower rod, and the spring into the rod insertion hole from a lower end of the lever main unit in this order and disposing the lever main unit in the shifter main unit;
assembling an insertion jig that is attachable and detachable to the position pin, the insertion jig being set such that a distal end portion thereof in an insertion direction is tapered and such that a rear end portion thereof in the insertion direction is set to be larger than a size of the position pin in the direction of the central axis;
inserting the insertion jig attached to the position pin into the position pin insertion hole, and pushing the insertion jig into a guide portion formed on at least one of a lower end portion of the upper rod and an upper end portion of the lower rod so as to dispose the position pin between the upper rod and the lower rod while sliding the upper rod and the lower rod; and
removing the insertion jig from the position pin disposed between the upper rod and the lower rod.
